(19) United States
(12) Patent Application Publication
(10) Pub. No.: US 2017/0179529 A1
(43) Pub. Date: Jun. 22, 2017

(54) SAFE ADDITIVE, ELECTROLYTE AND LITHIUM ION BATTERY USING THE SAME

(71) Applicants: JIANGSU HUADONG INSTITUTE OF LI-ION BATTERY CO., LTD., Jiangsu (CN); TSINGHUA UNIVERSITY, Beijing (CN)

(72) Inventors: Guan-Nan Qian, Suzhou (CN); Xiang-Ming He, Beijing (CN); Li Wang, Beijing (CN); Ju-Ping Yang, Beijing (CN); Yu-Ming Shang, Beijing (CN); Jian-Jun Li, Beijing (CN); Hong-Sheng Zhang, Suzhou (CN); Jian Gao, Beijing (CN)

(73) Assignees: JIANGSU HUADONG INSTITUTE OF LI-ION BATTERY CO., LTD., Jiangsu (CN); TSINGHUA UNIVERSITY, Beijing (CN)

(21) Appl. No.: 15/412,929

(22) Filed: Jan. 23, 2017

Related U.S. Application Data
(63) Continuation of application No. PCT/CN2015/081488, filed on Jun. 15, 2015.

(30) Foreign Application Priority Data
Jul. 24, 2014 (CN) 201410355817.0

(51) Int. Cl. H01M 10/0567; H01M 10/0568; H01M 10/0569; H01M 10/0525

(52) U.S. Cl. CPC H01M 10/0567; H01M 10/0525; H01M 10/0568; H01M 10/0569; H01M 2300/004; H01M 2220/30

(57) ABSTRACT

A safe additive for a lithium ion battery is disclosed. The safe additive comprises a maleimide type monomer and an enediyne type compound. The maleimide type monomer comprises at least one of a maleimide monomer, a bismaleimide monomer, a multimaleimide monomer and a maleimide type derivative monomer. An electrolyte liquid and a lithium ion battery containing the safe additive are also disclosed.

### CROSS-REFERENCE TO RELATED APPLICATIONS

This application claims all benefits accruing under 35 U.S.C. §119 from China Patent Application No. 201410355817.0, filed on Jul. 24, 2014 in the State Intellectual Property Office of China, the content of which is hereby incorporated by reference. This application is a continuation under 35 U.S.C. §120 of international patent application PCT/CN2015/081488 filed on Jun. 15, 2015, the content of which is also hereby incorporated by reference.

### FIELD

The present disclosure relates to safe additives, electrolytes, and lithium ion batteries using the same.

### BACKGROUND

With the rapid development and generalization of portable electronic products, there is an increasing need for lithium ion batteries due to their excellent performance and characteristics such as high energy density, long cyclic life, no memory effect, and light pollution when compared with conventional rechargeable batteries. However, the explosion of lithium ion batteries for mobile phones and laptops has aroused public attention as to the safety of the lithium ion batteries. The lithium ion batteries could release a large amount of heat if overcharged/discharged, short-circuited, or experiencing large current for long periods of time, which could cause burning or explosion due to runaway heat. Stricter safety standards are required in some applications such as electric vehicles.

### BRIEF DESCRIPTION OF THE DRAWINGS

Implementations are described by way of example only with reference to the attached figures.

FIG. 1 is a graph showing a synthetic route of one embodiment of an enediyne type compound represented by formula V.

FIG. 2 is a graph showing DSC curves of one embodiment of enediyne type compounds respectively represented by formula V and formula VI.

FIG. 3 is a graph showing cycling performances of one example and one comparative example of lithium ion batteries.

### DETAILED DESCRIPTION

A detailed description with the above drawings is made to further illustrate the present disclosure.

In one embodiment, a safe additive is provided. The safe additive can be a combination comprising an enediyne type compound and a maleimide type monomer. A molar ratio of the enediyne type compound to the maleimide type monomer can be about 0.01 to about 10, such as about 0.1 to about 5.

The maleimide type monomer can comprise at least one of a maleimide monomer, a bismaleimide monomer, a multimaleimide monomer, and a maleimide type derivative monomer.

The maleimide monomer can be represented by formula I:

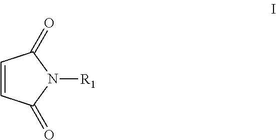

wherein R₁ is a monovalent organic substituent. R₁ can be —R, —RNH₂R, —C(O)CH₃, —CH₂OCH₃, —CH₂S(O)CH₃, monovalent alicyclic group, monovalent substituted aromatic group, or monovalent unsubstituted aromatic group, such as —C₆H₅, —C₆H₄C₆H₅, or —CH₂(C₆H₄)CH₃. R can be a hydrocarbyl with 1 to 6 carbon atoms, such as an alkyl with 1 to 6 carbon atoms. An atom, such as hydrogen, of a monovalent aromatic group can be substituted by a halogen, an alkyl with 1 to 6 carbon atoms, or a silane group with 1 to 6 carbon atoms to form the monovalent substituted aromatic group. The monovalent unsubstituted aromatic group can be phenyl, methyl phenyl, or dimethyl phenyl. An amount of benzene ring in the monovalent substituted aromatic group or the monovalent unsubstituted aromatic group can be 1 to 2.

The maleimide monomer can be selected from N-phenyl-maleimide, N-(p-methyl-phenyl)-maleimide, N-(m-methyl-phenyl)-maleimide, N-(o-methyl-phenyl)-maleimide, N-cyclohexane-maleimide, maleimide, maleimide-phenol, maleimide-benzocyclobutene, di-methylphenyl-maleimide, N-methyl-maleimide, ethenyl-maleimide, thio-maleimide, keto-maleimide, methylene-maleimide, maleimide-methyl-ether, maleimide-ethanediol, 4-maleimide-phenyl sulfone, and combinations thereof.

The bismaleimide monomer can be represented by formula II:

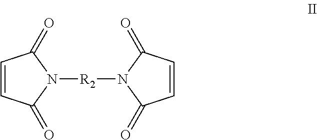

wherein R₂ is a bivalent organic substituent. R₂ can be —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —R—Si(CH₃)₂—O—Si(CH₃)₂—R—, bivalent alicyclic group, bivalent substituted aromatic group, or bivalent unsubstituted aromatic group, such as phenylene (—C₆H₄—), diphenylene (—C₆H₄C₆H₄—), substituted phenylene, substituted diphenylene, —(C₆H₄)—R₅—(C₆H₄)—, —CH₂(C₆H₄)CH₂—, or —CH₂(C₆H₄)(O)—. R₅ can be —CH₂—, —C(O)—, —C(CH₃)₂—, —O—, —O—O—, —S—, —S—S—, —S(O)—, or —(O)S(O)—. R can be a hydrocarbyl with 1 to 6 carbon atoms, such as an alkyl with 1 to 6 carbon atoms. An atom, such as hydrogen, of a bivalent aromatic group can be substituted by a halogen, an alkyl with 1 to 6 carbon atoms, or a silane group with 1 to 6 carbon atoms to form the bivalent substituted aromatic group. An amount of benzene ring in the bivalent substituted aromatic group or the bivalent unsubstituted aromatic group can be 1 to 2.

The bismaleimide monomer can be selected from N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′ -(1,3-phenylene)-bismaleimide, N,N′-bismaleimide sulfide, N,N′-bismaleimide disulfide, keto-N,N′-bismaleimide, N,N′-methylene-bismaleimide, bismaleimide-methyl-ether, 1,2-bismaleimide-1,2-glycol, N,N′-4,4′-diphenyl-ether-bismaleimide, 4,4′-bismaleimide-diphenyl sulfone, and combinations thereof.

The maleimide type derivative monomer can be obtained by substituting a hydrogen atom of the maleimide monomer, the bismaleimide monomer, or the multimaleimide monomer with a halogen atom.

The enediyne type compound can be represented by formula III or formula IV:

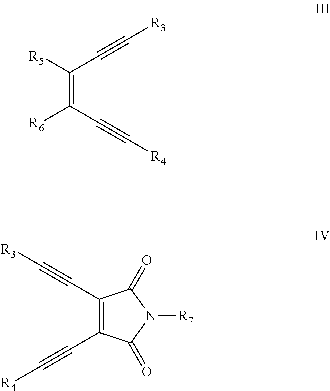

wherein R₃, R₄, R₅, R₆, and R₇ can be each, independent from one another, a hydrogen atom or a monovalent organic substituent.

R₃, R₄, R₅, R₆, and R₇ can be independently selected from H, —R′, —C(O)R′, —C(O)NHR′, —C(S)R′, —CH₂OCH₃, —Si(R′)₃, —C═CH, —C═CR′, —C≡CH, —C≡CR′, halogen, naphthenic base, monovalent substituted aromatic group, or monovalent unsubstituted aromatic group, such as —C₆H₅, —R′C₆H₅, —C₆H₄R′, —R′C₆H₄R′, —C₆H₄OR′, —C₆H₄NHR′. In one embodiment, R₃, R₄, R₅, R₆, and R₇ can be independently selected from —CH₂C₆H₅ or —CH₂C₆H₄CH₃. An atom, such as hydrogen, of a monovalent aromatic group can be substituted by a halogen or a silane group with 1 to 6 carbon atoms to form the monovalent substituted aromatic group. An amount of benzene ring in the monovalent substituted aromatic group or the monovalent unsubstituted aromatic group can be 1 to 2. R′ can be an alkyl with 1 to 6 carbon atoms.

The enediyne type compound can be made by conventional methods. In one embodiment, a terminal alkynyl can be crosslinked with an aryl group or a halide by a sonogashira reaction to obtain a —C—C≡C—C— group.

In one embodiment, the enediyne type compound can be represented by formula V or formula VI:

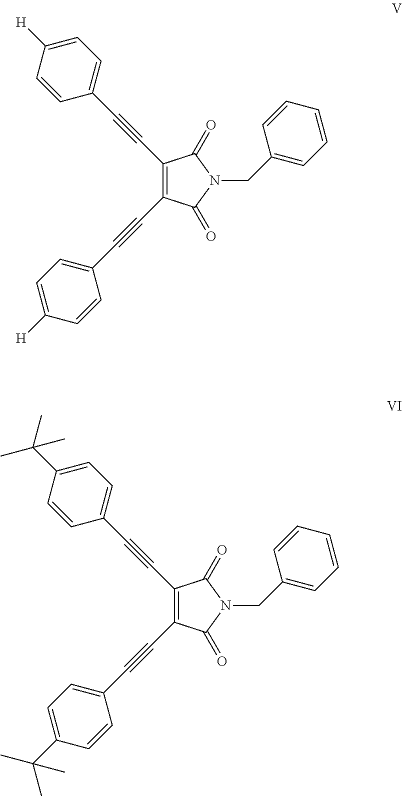 [SMILES: O=C1C(C#Cc2ccccc2)=C(C#Cc2ccccc2)C(=O)N1Cc1ccccc1 ; CC(C)(C)c1ccc(C#CC2=C(C#Cc3ccc(C(C)(C)C)cc3)C(=O)N(Cc3ccccc3)C2=O)cc1]

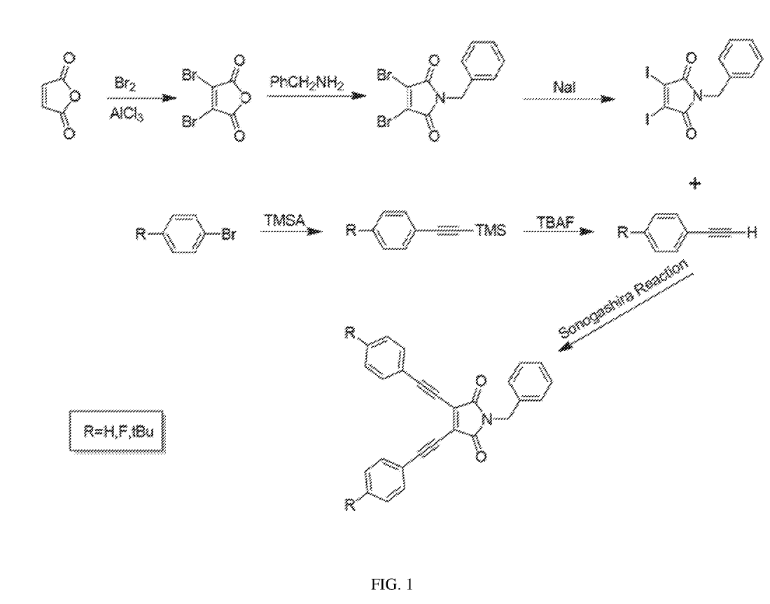

Referring to FIG. 1, in one embodiment, a method for making the enediyne type compound represented by formula V is provided. The method can comprise synthesizing 2,3-diiodo-N-benzylmaleimide starting from maleic anhydride; synthesizing phenylacetylene starting from bromobenzene; and connecting terminal alkynyl of the phenylacetylene to alkenyl of the 2,3-diiodo-N-benzylmaleimide by the sonogashira reaction to obtain the enediyne type compound represented by formula V.

The safe additive can be added in an electrolyte liquid for a lithium ion battery. The safe additive can be uniformly mixed with the electrolyte liquid. In one embodiment, a solution can be formed by adding the safe additive in a solvent, followed by mixing with the electrolyte liquid. In one embodiment, the safe additive can be directly added in the electrolyte liquid.

In one embodiment, the electrolyte liquid comprises an electrolyte salt, a non-aqueous solvent, and the safe additive. The electrolyte salt and the safe additive can be dissolved in the non-aqueous solvent. A mass-volume concentration of the safe additive in the electrolyte liquid can be about 0.01% (w/v) to about 10% (w/v), such as about 0.1% (w/v) to about 5% (w/v).

The electrolyte salt and the non-aqueous solvent can be selected according to the application of the electrolyte liquid.

The non-aqueous solvent can comprise at least one of cyclic carbonates, chain carbonates, cyclic ethers, chain ethers, nitriles, and amides, such as ethylene carbonate, diethyl carbonate, propylene carbonate, dimethyl carbonate, ethyl methyl carbonate, butylene carbonate, gamma-butyrolactone, gamma-valerolactone, dipropyl carbonate, N-methyl pyrrolidone, N-methylformamide, N-methylacetamide, N,N-dimethylformamide, N,N-diethylformamide, diethyl ether, acetonitrile, propionitrile, anisole, succinonitrile, adiponitrile, glutaronitrile, dimethyl sulfoxide, dimethyl sulfite, vinylene carbonate, ethyl methyl carbonate, dimethyl carbonate, diethyl carbonate, fluoroethylene carbonate, chloropropylene carbonate, acetonitrile, succinonitrile, methoxymethylsulfone, tetrahydrofuran, 2-methyltetrahydrofuran, epoxy propane, methyl acetate, ethyl acetate, propyl acetate, methyl butyrate, ethyl propionate, methyl propionate, 1,3-dioxolane, 1,2-diethoxyethane, 1,2-dimethoxyethane, and 1,2-dibutoxy.

The electrolyte salt can be a lithium salt that comprises but is not limited to at least one of lithium chloride (LiCl), lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium hexafluoroantimonate(LiSbF₆), lithium perchlorate (LiClO₄), Li[BF₂(C₂O₄)], Li[PF₂(C₂O₄)₂], Li[N(CF₃SO₂)₂], Li[C(CF₃SO₂)₃], and lithium bisoxalatoborate (LiBOB).

In one embodiment, an electrochemical battery is provided. The electrochemical battery can comprise a cathode, an anode, a separator and the electrolyte liquid. The cathode and the anode can be spaced from each other by the separator. The electrolyte liquid can be disposed between the cathode and the anode. The cathode can further comprise a cathode current collector and a cathode material layer located on a surface of the cathode current collector. The anode can further comprise an anode current collector and an anode material layer located on a surface of the anode current collector. The cathode material layer and the anode material layer can be relatively arranged and spaced by the separator.

When the electrochemical battery is the lithium ion battery, the cathode material layer can comprise a cathode active material. The cathode active material can be at least one of layer type lithium transition metal oxides, spinel type lithium transition metal oxides, and olivine type lithium transition metal oxides, such as olivine type lithium iron phosphate, layer type lithium cobalt oxide, layer type lithium manganese oxide, spinel type lithium manganese oxide, lithium nickel manganese oxide, and lithium cobalt nickel manganese oxide. The anode material layer can comprise an anode active material, such as at least one of lithium titanate, graphite, mesophase carbon micro beads (MCMB), acetylene black, mesocarbon miocrobead, carbon fibers, carbon nanotubes, and cracked carbon.

The cathode material layer and the anode material layer can respectively comprise a conducting agent and a binder. The conducting agent can be carbonaceous materials, such as at least one of carbon black, conducting polymers, acetylene black, carbon fibers, carbon nanotubes, and graphite. The binder can be at least one of polyvinylidene fluoride (PVDF), polyvinylidene fluoride, polytetrafluoroethylene (PTFE), fluoro rubber, ethylene oropylene diene monomer, and styrene-butadiene rubber (SBR).

The separator can be polyolefin microporous membrane, modified polypropylene fabric, polyethylene fabric, glass fiber fabric, superfine glass fiber paper, vinylon fabric, or composite membrane of nylon fabric and wettable polyolefin microporous membrane composited by welding or bonding.

### EXAMPLES

### Example 1

Half Cell

1 M of LiPF₆ is dissolved in a solvent mixture of EC/DEC/EMC=1/1/1(v/v/v) to obtain an electrolyte liquid. The safe additive is consisted of the enediyne type compound represented by formula V and bismaleimide (BMI). A concentration of the enediyne type compound represented by formula V in the electrolyte liquid is 10.1% (w/v). A concentration of the bismaleimide (BMI) in the electrolyte liquid is 1% (w/v). A lithium ion battery is assembled by having lithium cobalt oxides as a cathode active material and metal lithium as a counter electrode.

Full Cell

94% of LiNi_{1/3}Co_{1/3}Mn_{1/3}O₂, 3% of PVDF, and 3% of conducting graphite by mass percent are mixed and dispersed by the NMP to form a slurry. The slurry is coated on an aluminum foil, vacuum dried at 120° C., pressed and cut to obtain a cathode.

94% of graphite anode, 3.5% of PVDF, and 2.5% of conducting graphite by mass percent are mixed and dispersed by the NMP to form a slurry. The slurry is coated on an aluminum foil, vacuum dried at about 100° C., pressed and cut to obtain an anode.

An electrolyte liquid of the full cell is same as the half cell. The cathode and the anode are assembled and rolled up to form a 63.5 mm×51.5 mm×4.0 mm sized soft packaged battery.

### Example 2

Full Cell

A cathode and an anode of Example 2 both are same as the full cell of Example 1.

1 M of LiPF₆ is dissolved in a solvent mixture of EC/DEC/EMC=1/1/1(v/v/v) to obtain an electrolyte liquid. The safe additive is consisted of the enediyne type compound represented by formula VI and bismaleimide (BMI). A concentration of the enediyne type compound represented by formula VI in the electrolyte liquid is 0.1% (w/v). A concentration of the bismaleimide (BMI) in the electrolyte liquid is 1% (w/v). The cathode and the anode are assembled and rolled up to form a 63.5 mm×51.5 mm×4.0 mm sized soft packaged battery.

### Comparative Example 1

Full Cell

A cathode and an anode of Comparative Example 1 both are same as the full cell of Example 1.

1% (w/v) of bismaleimide and 1 M of LiPF₆ are dissolved in a solvent mixture of EC/DEC/EMC=1/1/1(v/v/v) to obtain an electrolyte liquid. The cathode and the anode are assembled and rolled up to form a 63.5 mm×51.5 mm×4.0 mm sized soft packaged battery.

### Comparative Example 2

Half Cell

1 M of LiPF₆ is dissolved in a solvent mixture of EC/DEC/EMC=1/1/1(v/v/v) to obtain an electrolyte liquid. The lithium ion battery is assembled by having lithium cobalt oxides as a cathode active material and metal lithium as a counter electrode.

Full Cell

A cathode and an anode of Comparative Example 2 both are same as the full cell of Example 1.

1 M of LiPF₆ are dissolved in a solvent mixture of EC/DEC/EMC=1/1/1(v/v/v) to obtain an electrolyte liquid. The cathode and the anode are assembled and rolled up to form a 63.5 mm×51.5 mm×4.0 mm sized soft packaged battery.

Differential Scanning Calorimeter Analysis

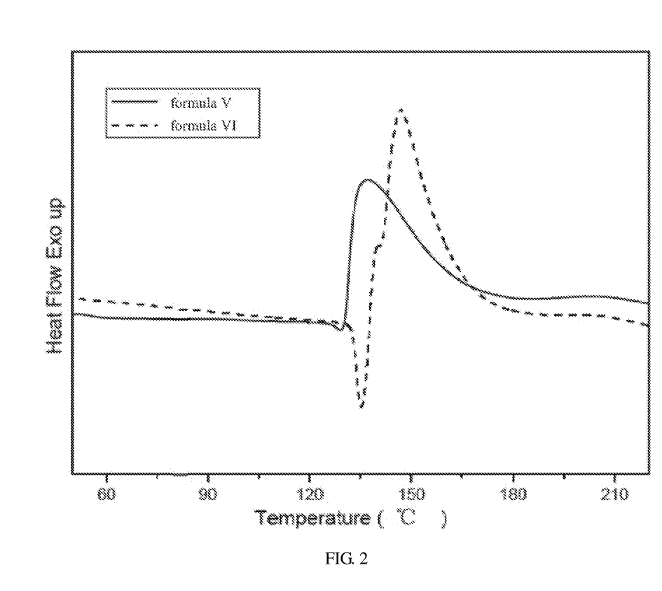

FIG. 2 is a graph showing DSC curves of the enediyne type compounds respectively represented by formula V and formula VI. Exothermic peaks in FIG. 2 are heat signals released in a diradical cyclization process of the enediyne type compounds. It can be seen from FIG. 2 that initiation temperatures of the enediyne type compounds respectively represented by formula V and formula VI to generate the diradical are respectively about 130° C., 140° C. and 160° C., and peak temperatures thereof are respectively about 140° C., 150° C. and 170° C.

Electrochemical Performance Test

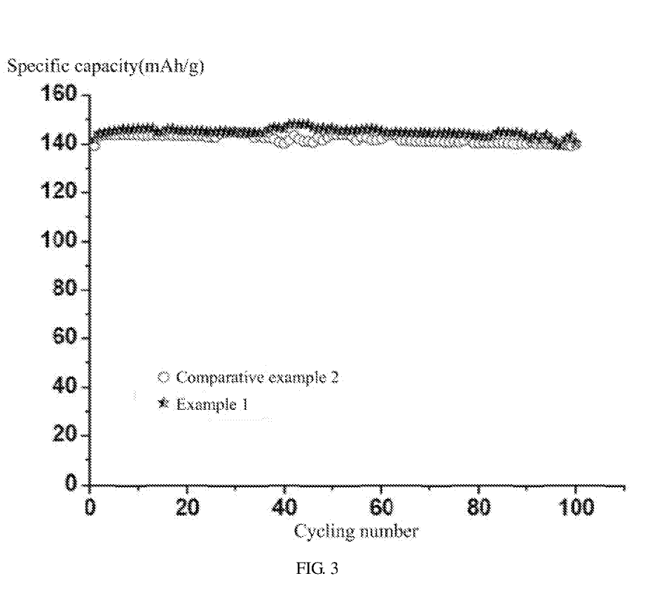

The half cells of Example 1 and Comparative Example 2 are charged and discharged at a constant current rate of 0.2 C in the voltage ranging from 2.8V to 4.3V at room temperature. FIG. 3 is a graph showing cycling performances of Example 1 and Comparative Example 2 of the half cells. It can be seen from FIG. 3 that discharge capacities of the half cells are consistent with each other, which shows that the addition of the safe additive has insignificant effect on the electrochemical and cycling performances to the battery.

Hot Box Test

The lithium ion batteries of Examples 1-3 and Comparative Examples 1-2 are placed and cycled in a hot box heated to 150° C., and test results are listed in Table 1. It can be seen from Table 1 that thermal stability and safety at high temperature of the lithium ion battery are increased by adding the safe additive, while an electrolyte liquid without the safe additive, or in which only bismaleimide is added cannot protect the lithium ion battery at that high temperature.

TABLE 1

| | | | Comparative | Comparative |
|---|---|---|---|---|
| | Example 1 | Example 2 | Example 1 | Example 2 |
| Hot box heated to | ◯ | ◯ | X | X |
| 150° C. | | | | |

wherein ◯ represents that the lithium ion battery does not burn nor explode, and X represents that the lithium ion battery burns or explodes.

In the present disclosure, the safe additive can be a combination of the enediyne type compound and the maleimide type monomer. The enediyne type compound can have a diradical transition state at a high temperature thereby taking hydrogen atom from hydrogen donor to have a cyclization reaction. When a thermal runaway phenomenon occurs to the lithium ion battery, the generation of the diradical in the enediyne type compound can be initiated by heat. The diradical initiates polymerization and crosslink of the maleimide type monomer, which has a lockdown effect to block transportation of the lithium ions and break off the electrochemical reaction, which avoids intense heat release and explosion.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A safe additive for a lithium ion battery, comprising an enediyne type compound and a maleimide type monomer, wherein
the maleimide type monomer is selected from the group consisting of maleimide monomer, bismaleimide monomer, multimaleimide monomer, maleimide type derivative monomer, and combinations thereof; and
the enediyne type compound is represented by formula III or formula IV: 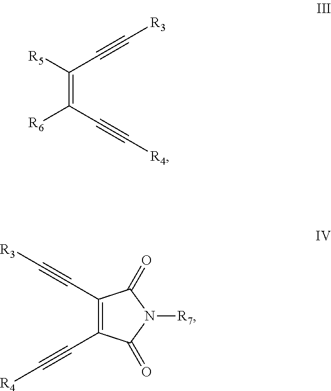
wherein R₃, R₄, R₅, R₆, and R₇ is each, independent from one another, a hydrogen atom or a monovalent organic substituent.

2. The safe additive of claim 1, wherein R₃, R₄, R₅, R₆, and R₇ is independently selected from the group consisting of H, —R′, —C(O)R′, —C(O)NHR′, —C(S)R′, —CH₂OCH₃, —Si(R′)₃, —C═CH, —C═CR′, —C≡CH, —C≡CR′, halogen, naphthenic base, monovalent substituted aromatic group, and monovalent unsubstituted aromatic group; an atom of a monovalent aromatic group is substituted by a halogen or a silane group with 1 to 6 carbon atoms to form the monovalent substituted aromatic group; R′ is an alkyl with 1 to 6 carbon atoms.

3. The safe additive of claim 1, wherein R₃, R₄, R₅, R₆, and R₇ is independently selected from the group consisting of —C₆H₅, —R′C₆H₅, —C₆H₄R′, —R′C₆H₄R′, —C₆H₄OR′ and —C₆H₄NHR′, R′ is an alkyl with 1 to 6 carbon atoms.

4. The safe additive of claim 1, wherein the maleimide monomer is represented by formula I: 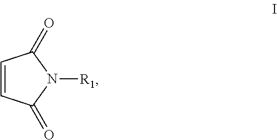
wherein R₁ is a monovalent organic substitute.

5. The safe additive of claim 4, wherein R₁ is selected from the group consisting of —R, —RNH₂R, —C(O)CH₃, —CH₂OCH₃, —CH₂S(O)CH₃, —C₆H₅, —C₆H₄C₆H₅, —CH₂C₆H₄CH₃, and monovalent alicyclic group; R is a hydrocarbyl with 1 to 6 carbon atoms.

6. The safe additive of claim 1, wherein the maleimide monomer is selected from the group consisting of N-phenyl-maleimide, N-(p-methyl-phenyl)-maleimide, N-(m-methyl-phenyl)-maleimide, N-(o-methyl-phenyl)-maleimide, N-cyclohexane-maleimide, maleimide, maleimide-phenol, maleimide-benzocyclobutene, di-methylphenyl-maleimide, N-methyl-maleimide, ethenyl-maleimide, thio-maleimide, keto-maleimide, methylene-maleimide, maleimide-methyl-ether, maleimide-ethanediol, 4-maleimide-phenyl sulfone, and combinations thereof.

7. The safe additive of claim 1, wherein the bismaleimide monomer is represented by formula II: 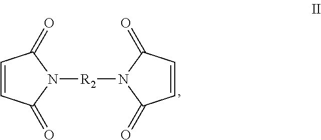
wherein R₂ is a bivalent organic substitute.

8. The safe additive of claim 7, wherein R₂ is selected from the group consisting of —R—, —RNH₂R—, —C(O)CH₂—, —CH₂OCH₂—,—C(O)—, —O—, —O—O—, —S—, —S—S—, —S(O)—, —CH₂S(O)CH₂—, —(O)S(O)—, —CH₂(C₆H₄)CH₂—, —CH₂(C₆H₄)(O)—, —R—Si(CH₃)₂—O—Si(CH₃)₂—R—, —C₆H₄—, —C₆H₄C₆H₄—, bivalent alicyclic group and —(C₆H₄)—R₅—(C₆H₄)—; R₅ is —CH₂—, —C(O)—, —C(CH₃)₂—, —O—, —O—O—, —S—, —S—S—, —S(O)—, or —(O)S(O)—; and R is a hydrocarbyl with 1 to 6 carbon atoms.

9. The safe additive of claim 1, wherein the bismaleimide monomer is selected from the group consisting of N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-bismaleimide sulfide, N,N′-bismaleimide disulfide, keto-N,N′-bismaleimide, N,N′-methylene-bismaleimide, bismaleimide-methyl-ether, 1,2-bismaleimide-1,2-glycol, N,N′-4,4′-diphenyl-ether-bismaleimide, 4,4′-bismaleimide-diphenyl sulfone, and combinations thereof.

10. The safe additive of claim 1, wherein a molar ratio of the enediyne type compound to the maleimide type monomer is about 0.01 to about 10.

11. An electrolyte liquid, comprising an electrolyte salt, a non-aqueous solvent, and a safe additive for a lithium ion battery, wherein
the safe additive comprises an enediyne type compound and a maleimide type monomer;
the maleimide type monomer is selected from the group consisting of maleimide monomer, bismaleimide monomer, multimaleimide monomer, maleimide type derivative monomer, and combinations thereof; and
the enediyne type compound is represented by formula III or formula IV: 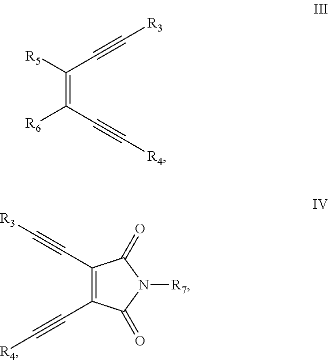
wherein R₃, R₄, R₅, R₆, and R₇ is each, independently of one another, a hydrogen atom or a monovalent organic substituent.

12. The electrolyte liquid of claim 11, wherein a mass-volume concentration of the safe additive is about 0.01% to about 10%.

13. A lithium ion battery, comprising a cathode, an anode, a separator, and an electrolyte liquid, wherein
the electrolyte liquid comprises an electrolyte salt, a non-aqueous solvent, and a safe additive;
the safe additive comprises an enediyne type compound and a maleimide type monomer;
the maleimide type monomer is selected from the group consisting of maleimide monomer, bismaleimide monomer, multimaleimide monomer, maleimide type derivative monomer, and combinations thereof; and
the enediyne type compound is represented by formula III or formula IV: 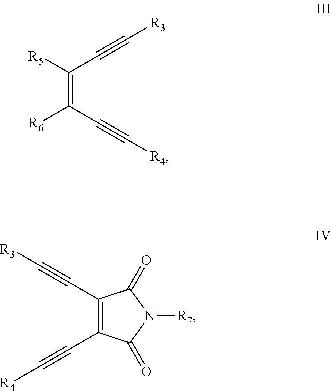
wherein R₃, R₄, R₅, R₆, and R₇ is each, independently of one another, a hydrogen atom or a monovalent organic substituent.
